(19) United States
(12) Patent Application Publication
(10) Pub. No.: US 2007/0005850 A1
(43) Pub. Date: Jan. 4, 2007

(54) Port multiplier mapping apparatus, systems, and methods

(75) Inventors: Nai-chih Chang, Shrewsbury, MA (US); Pak-lung Seto, Shrewsbury, MA (US); Victor Lau, Marlboro, MA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/170,848

(22) Filed: Jun. 29, 2005

(51) Int. Cl. G06F 13/38

(52) U.S. Cl. 710/74

(57) ABSTRACT

Apparatus and systems, as well as methods and articles, may operate to relate a port multiplier (PM) tag associated with a frame information structure frame to a remote node context index and to a validity flag using a hardware PM look-up table in a host bus adapter.

### TECHNICAL FIELD

Various embodiments described herein relate to digital communications generally, including apparatus, systems, and methods used to process frames in a host bus adapter.

### BACKGROUND INFORMATION

Serial-attached advanced technology attachment (SATA) specifications inform that up to fifteen SATA devices (e.g., disk drives) may be attached behind a port multiplier (PM) connected to a SATA host bus adapter (HBA). The HBA may comprise a traditional, non connection-oriented SATA HBA, an input-output (I/O) controller supporting a SATA/serial-attached small computer system interface-SATA tunneled protocol (SAS-STP) feature, or a storage controller with a SATA/SAS-STP feature, among others. The HBA may in turn allocate up to sixteen remote node contexts (RNCs) associated with the devices attached to the PM, fifteen for SATA devices such as drives and one reserved for management communications with the PM. An RNC may comprise a set of parameters associated with a particular SATA device, including link rate, device address, supported protocols, and status register contents, among others. A remote node context index (RNI) may comprise an integer representative of a particular RNC. For additional information, please see Serial ATA: High Speed Serialized AT Attachment Revision 1.0a (7 Jan. 2003) from the ATA Working Group website at www.serialata.org. See also Serial ATA International Organization: Port Multiplier Revision 1.2 (27 Jan. 2005) at www.sata-io.org.

A typical HBA design may utilize processor cycles from a host processor or from a general purpose processor located in the HBA (hereinafter “firmware”) to process communication frames transferred between the HBA and a SATA end-node device. These frames may be referred to as “frame information structure” (FIS) frames. FIS frames associated with a SATA device connected to a particular PM port and utilizing an associated RNI may include a port identification field in a FIS header called the PM tag. The firmware may utilize considerable CPU and memory cycles in operations to relate the PM tag and the associated RNI each time a FIS frame is either received or assembled for transmission.

### BRIEF DESCRIPTION OF THE DRAWINGS

FIG. 1 is a block diagram of an apparatus and a representative system according to various embodiments of the invention.

FIG. 2A is a flow diagram illustrating several methods according to various embodiments of the invention.

FIG. 2B is a continuation of the flow diagram from FIG. 2A.

FIG. 3 is a block diagram of an article according to various embodiments of the invention.

### DETAILED DESCRIPTION

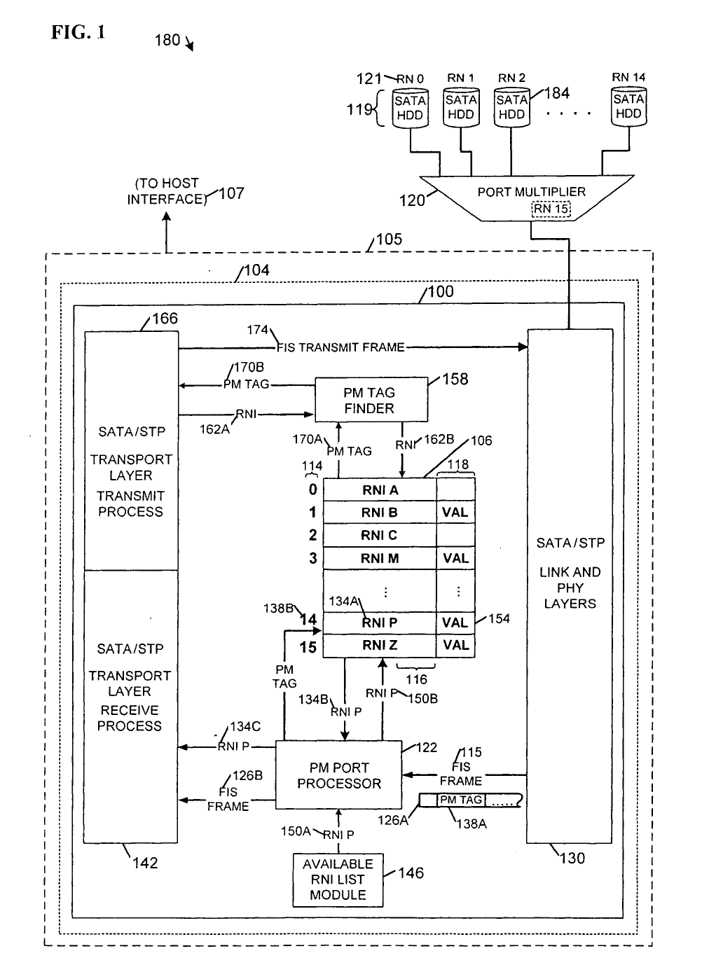

FIG. 1 comprises a block diagram of an apparatus 100 and a system 180 according to various embodiments of the invention. The apparatus 100 may be contained within a hardware protocol engine 104 associated with an HBA 105. The HBA 105 may be coupled to a host interface 107. The HBA 105 may include an I/O controller, storage controller, or traditional HBA, as previously described. The apparatus 100 may include a hardware PM look-up table (LUT) 106 in the HBA 105. The LUT 106 may relate a PM tag 114 contained in a FIS frame 115 to an RNI 116 associated with the FIS frame 115. The FIS frame 115 may be formatted according to Serial ATA High Speed Serial AT Attachment specification 1.0a. The apparatus 100 may also include a validity flag 118 associated with the RNI 116 to indicate that an RNC associated with the RNI 116 is active.

The HBA 105 may comprise a SATA HBA, a serial-attached small computer system interface-SATA tunneled protocol (SAS-STP) HBA, or both. The RNI 116 may comprise an identifier associated with a set of data structures used by the HBA 105 to communicate with a SATA device 119 attached to a PM 120, as previously described. The PM tag 114 may comprise a PM port identifier 121.

The apparatus 100 may also include a PM port processor 122 coupled to the hardware PM LUT 106 to receive a FIS frame 126A, 126B from a link layer 130 associated with the HBA 105. The FIS frame 126A, 126B may be referred to hereinafter as the “receive” FIS frame. The PM port processor 122 may look up an RNI 134A, 134B, 134C (referred to hereinafter as the “receive” RNI) from the hardware PM. LUT 106. The receive RNI 134A, 134B, 134C may be associated with a PM tag 138A, 138B (“receive” PM tag 138A, 138B) in the receive FIS frame 126A. The port processor 122 may pass both the receive RNI 134C and the receive FIS frame 126B to a transport layer receive process 142 in the HBA 105.

The apparatus 100 may also include an available RNI list module 146 coupled to the PM port processor 122 to supply an available RNI 150A, 150B to the PM port processor 122 to populate the hardware PM LUT 106 if a validity flag 154 (“receive” validity flag 154) associated with the receive PM tag 138A, 138B indicates that the receive RNI 134A is not valid in the hardware PM LUT 106.

The apparatus 100 may further include a PM tag finder module 158 coupled to the hardware PM LUT 106. The PM tag finder module 158 may receive an RNI 162A, 162B (“transmit” RNI 162A, 162B) from a transport layer transmit process 166 associated with the HBA 105. The tag finder module 158 may use the transmit RNI 162B to look up a PM tag 170A, 170B (“transmit” PM tag 170A, 170B) in the hardware PM LUT 106. Thus, the transmit PM tag 170A, 170B may be related by the hardware PM LUT 106 to the transmit RNI 162B. The PM tag finder module 158 may pass the transmit PM tag 170B to the transport layer transmit process 166, perhaps for insertion into a FIS frame 174 to be transmitted to the link layer 130.

In another embodiment, a system 180 may comprise one or more of the apparatus 100, including a hardware PM LUT 106, a PM port processor 122, an available RNI list module 146, and a PM tag finder module 158 in an HBA 105, as previously described. The system 180 may also include a disk drive 184 coupled to the HBA 105 as a target device. In some embodiments the disk drive 184 may be coupled to the HBA 105 via a PM 120.

Components of the system 180, including the hardware PM LUT 106, the PM port processor 122, and the available RNI list module 146 may comprise a remote node context address list to assign remote node context addresses as required by the target devices 119 attaching to the HBA 105.

Any of the components previously described can be implemented in a number of ways, including embodiments in software. Thus, the apparatus 100; hardware protocol engine 104; HBA 105; hardware PM LUT 106; host interface 107; PM tags 114, 138A, 138B, 170A, 170B; FIS frames 115, 126A, 126B, 174; RNIs 116, 134A, 134B, 134C, 150A, 150B, 162A, 162B; validity flags 118, 154; SATA device 119; PM 120; PM port identifier 121; PM port processor 122; link layer 130; transport layer receive process 142; available RNI list module 146; PM tag finder module 158; transport layer transmit process 166; system 180; and disk drive 184 may all be characterized as “modules” herein.

The modules may include hardware circuitry, single or multi-processor circuits, memory circuits, software program modules and objects, firmware, and combinations thereof, as desired by the architect of the apparatus 100 and system 180 and as appropriate for particular implementations of various embodiments.

The apparatus and systems of various embodiments can be used in applications other than relating a PM tag associated with a FIS frame to an RNI in a SATA or SAS-STP HBA. Thus, various embodiments of the invention are not to be so limited. The illustrations of apparatus 100 and system 180 are intended to provide a general understanding of the structure of various embodiments, and they are not intended to serve as a complete description of all the elements and features of apparatus and systems that might make use of the structures described herein.

Applications that may comprise the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Embodiments herein may be included as sub-components within a variety of electronic systems, such as televisions, cellular telephones, personal computers, workstations, radios, video players, audio players (e.g., mp3 players), vehicles, and others. Some embodiments may include a number of methods.

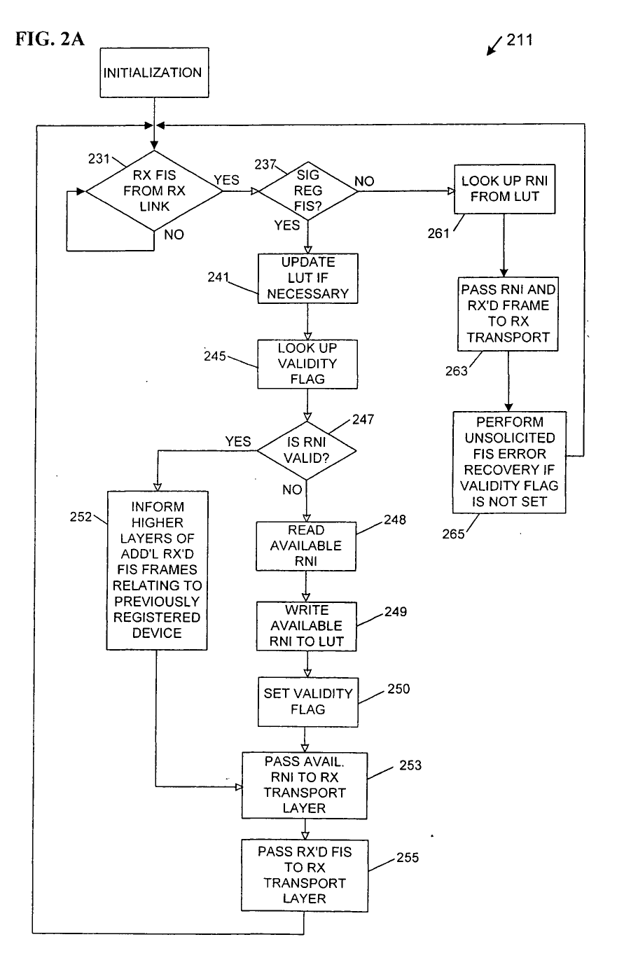

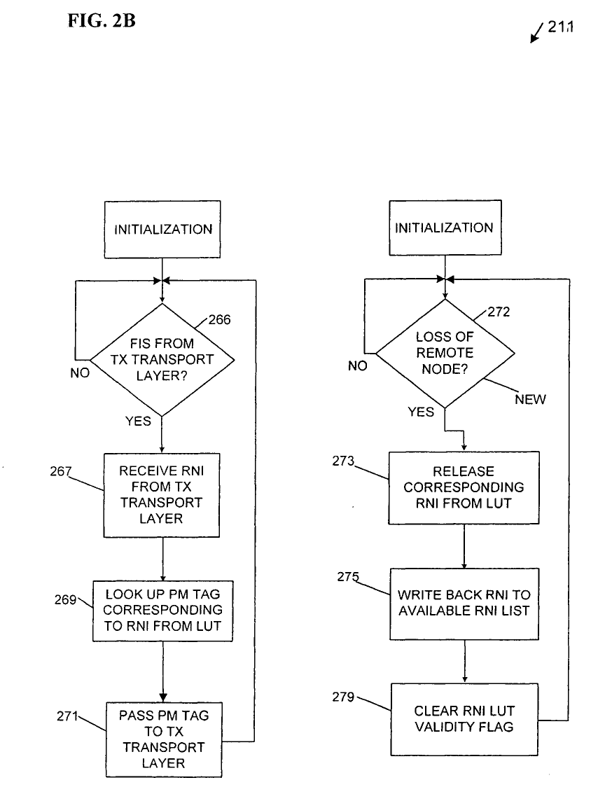

FIG. 2 is a flow diagram illustrating several methods according to various embodiments of the invention. One such method 211 may operate to isolate PM tag management operations from other remote node and task context processing in the HBA using PM tag management hardware structures, as previously described. The method 211 may relate a PM tag associated with a FIS frame to an RNI and to a validity flag using a hardware PM LUT in an HBA. The method 211 may be performed by a hardware protocol engine within the HBA. The HBA may comprise a SATA HBA, a SAS-STP HBA, or both. Some operations disclosed herein may be performed by a PM port processor component of the hardware protocol engine.

The method 211 may include receiving a receive FIS frame from a link layer associated with the HBA, at block 231, and with determining whether the receive FIS frame comprises a signature register FIS frame or a non-signature register FIS frame, at block 237. If the receive FIS frame comprises a signature register FIS frame, the method 211 may continue at block 241 with updating the hardware PM LUT, if necessary.

That is, the method 211 may include looking up a receive validity flag entry in the hardware PM LUT at a table index corresponding to a receive PM tag read from the receive FIS frame, at block 245. The method 211 may also include testing the receive validity flag to determine whether an existing RNI entry at the table index is valid in the hardware PM LUT, at block 247. If the existing RNI entry is not valid, the method 211 may continue at block 248 with reading an available RNI from an available RNI list module. The method 211 may further include writing the available RNI to the hardware PM LUT as the receive RNI at the table index, at block 249, and setting the receive validity flag entry to indicate that the receive RNI is valid, at block 250.

If the existing RNI entry is valid, signature register FIS frame handling may proceed at block 252 with informing an application layer or a device management function that an additional signature register FIS associated with a previously-registered device was received. The method 211 may continue at block 253 with passing the receive RNI associated with the receive FIS frame to a transport layer receive process in the HBA. The method 211 may also include passing the receive FIS frame to the transport layer receive process, at block 255.

If the receive FIS frame comprises a non-signature register FIS frame, it may be expected that the LUT validity flag associated with the receive FIS frame PM tag is set. If the flag is set, the method 211 may further include looking up the receive RNI associated with the receive PM tag in the receive FIS frame in the hardware PM LUT at block 261. The method 211 may also include passing both the receive RNI and the receive FIS frame to the transport layer receive process, at block 263. If the validity flag associated with a non-signature register receive FIS frame is found to be cleared, the method 211 may include performing an unsolicited FIS error recovery operation at block 265.

FIS frame transmit operations associated with the method 211 may include waiting for a FIS transmit frame to be sent from a transport layer transmit process in the HBA, at block 266. When a transmit frame becomes pending, the method 211 may also include receiving a transmit RNI from the transport layer at a PM tag finder module coupled to the hardware PM LUT, at block 267. The method 211 may also include looking up a transmit PM tag in the hardware PM LUT, the transmit PM tag related by the hardware PM LUT to the transmit RNI, at block 269. Transmit operations may further include passing the transmit PM tag to the transport layer transmit process, at block 271. The transmit PM tag may be inserted into a header in a FIS frame to be passed by the transport layer to the link layer.

Upon loss of a remote node (e.g., disconnection of a target SATA device from a PM or deactivation of the remote node) at block 272, the method 211 may include releasing the associated receive RNI from the hardware PM LUT, at block 273. Release operations may include writing back the receive RNI to the available RNI list module, at block 275, and clearing the hardware PM look-up module validity flag associated with receive RNI, at block 279.

It may be possible to execute the activities described herein in an order other than the order described. And, various activities described with respect to the methods identified herein can be executed in repetitive, serial, or parallel fashion. Information including parameters, commands, operands, and other data can be sent and received in the form of one or more carrier waves.

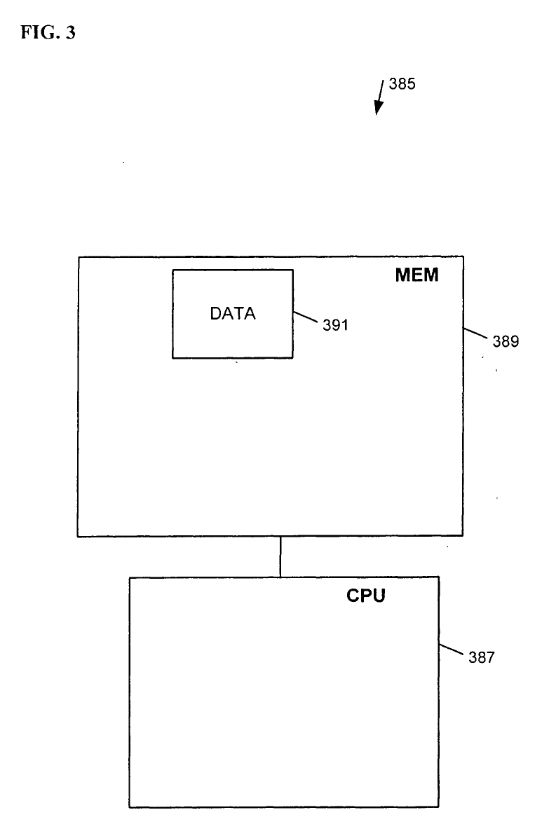

One of ordinary skill in the art will understand the manner in which a software program can be launched from a computer-readable medium in a computer-based system to execute the functions defined in the software program. Various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 3 below.

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including electrical, optical, or electromagnetic elements). The medium may contain associated information 391 (e.g., computer program instructions, data, or both) which, when accessed, results in a machine (e.g., the processor(s) 387) relating a PM tag associated with a FIS frame to an RNI and to a validity flag using a hardware PM look-up table in an HBA, as previously described. The HBA may comprise a SATA HBA, a SAS-STP HBA, or both. Other activities may include isolating PM tag management operations from other remote node and task context processing in the HBA using PM tag management hardware structures.

Implementing the apparatus, systems, and methods disclosed herein may operate to associate a PM tag in a FIS frame, an RNI, and a validity flag using a hardware PM LUT to facilitate frame communications and processing in an HBA.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a hardware port multiplier (PM) look-up table (LUT) in a host bus adapter (HBA) to relate a PM tag contained in a frame information structure (FIS) frame to a remote node context index (RNI) associated with the FIS frame; and
a PM port processor coupled to the hardware PM LUT to receive a received FIS frame from a link layer associated with the HBA, to look up a received RNI associated with a received PM tag in the received FIS frame from the hardware PM LUT, and to pass both the received RNI and the received FIS frame to a transport layer receive process in the HBA.

2. The apparatus of claim 1, wherein the HBA comprises at least one of a serial advanced technology attachment (SATA) HBA and a serial-attached small computer system interface-SATA tunneled protocol HBA.

3. The apparatus of claim 2, wherein the RNI comprises an identifier associated with a set of data structures used by the HBA to communicate with a SATA device attached to the PM.

4. The apparatus of claim 1, wherein the PM tag comprises a PM port identifier.

5. The apparatus of claim 1, further including:
a validity flag associated with the RNI to indicate that a remote node context associated with the RNI is active.

6. The apparatus of claim 1, wherein the FIS frame is formatted according to Serial ATA High Speed Serial AT Attachment specification 1.0a.

7. The apparatus of claim 1, further including:
an available RNI list module coupled to the PM port processor to supply an available RNI to the PM port processor to populate the hardware PM LUT if a received validity flag associated with the received PM tag indicates that the received RNI is not valid in the hardware PM LUT.

8. The apparatus of claim 1, further including:
a PM tag finder module coupled to the hardware PM LUT to receive a transmit RNI from a transport layer transmit process associated with the HBA, to look up a transmit PM tag in the hardware PM LUT, the transmit PM tag related by the hardware PM LUT to the transmit RNI, and to pass the transmit PM tag to the transport layer transmit process.

9. The apparatus of claim 1, contained within a hardware protocol engine associated with the HBA.

10. A system, including:
a hardware port multiplier (PM) look-up table (LUT) in a host bus adapter (HBA) to relate a PM tag contained in a frame information structure (FIS) frame to a remote node context index (RNI) and to a validity flag; and
a PM port processor coupled to the hardware PM LUT to receive a receive FIS frame from a link layer associated with the HBA, to look up a receive RNI associated with a receive PM tag in the receive FIS frame from the hardware PM LUT, and to pass both the receive RNI and the receive FIS frame to a transport layer receive process in the HBA; and
a disk drive coupled to the HBA as a target device.

11. The system of claim 10, further including:
an available RNI list module coupled to the PM port processor to supply an available RNI to the PM port processor to populate the hardware PM LUT if a receive validity flag associated with the receive PM tag indicates that the receive RNI is not valid in the hardware PM LUT.

12. The system of claim 10, further including:
a PM tag finder module coupled to the hardware PM LUT to receive a transmit RNI from a transport layer transmit process associated with the HBA, to look up a transmit PM tag in the hardware PM LUT, the transmit PM tag related by the hardware PM LUT to the transmit RNI, and to pass the transmit PM tag to the transport layer transmit process.

13. The system of claim 12, wherein the hardware PM LUT, the PM port processor, and the available RNI list module comprise a remote node context address list to assign remote node context addresses as required by target devices attaching to the HBA.

14. A method, including:
relating a port multiplier (PM) tag associated with a frame information structure (FIS) frame to a remote node context index (RNI) and to a validity flag using a hardware PM look-up table (LUT) in a host bus adapter (HBA).

15. The method of claim 14, performed by a hardware protocol engine within the HBA.

16. The method of claim 14, further including:
receiving a receive FIS frame from a link layer associated with the HBA; and
determining whether the receive FIS frame comprises a signature register FIS frame or a non-signature register FIS frame.

17. The method of claim 16, further including:
performing the following activities if the receive FIS frame comprises a signature register FIS frame:
updating the hardware PM LUT if necessary;
passing a receive RNI associated with the receive FIS frame to a transport layer receive process in the HBA using a PM port processor coupled to the hardware PM LUT; and
passing the receive FIS frame to the transport layer receive process.

18. The method of claim 17, wherein updating the hardware PM LUT if necessary further comprises:
looking up a receive validity flag entry in the hardware PM LUT at a table index corresponding to a receive PM tag read from the receive FIS frame;
reading an available RNI from an available RNI list module if the receive validity flag entry indicates that an existing RNI entry at the table index is not valid in the hardware PM LUT;
writing the available RNI to the hardware PM LUT as the receive RNI at the table index if the receive validity flag entry indicates that the existing RNI entry is not valid; and
setting the receive validity flag entry to indicate that the receive RNI is valid.

19. The method of claim 18, further including:
releasing the receive RNI from the hardware PM LUT upon disconnection of a target SATA device from a PM by:
writing back the receive RNI to the available RNI list module; and
clearing the hardware PM look-up module validity flag associated with receive RNI.

20. The method of claim 19, further including:
performing the following activities in the specified order if the receive FIS frame comprises a non-signature register FIS frame and the validity flag is set:
looking up in the hardware PM LUT the receive RNI associated with the receive PM tag in the receive FIS frame; and
passing both the receive RNI and the receive FIS frame to the transport layer receive process using the PM port processor coupled to the hardware PM LUT.

21. The method of claim 20, further including:
performing an unsolicited FIS error recovery operation if the receive FIS frame comprises a non-signature register FIS frame and the validity flag is not set.

22. The method of claim 21, further including:
receiving a transmit RNI from a transport layer transmit process in the HBA at a PM tag finder module coupled to the hardware PM LUT;
looking up a transmit PM tag in the hardware PM LUT, the transmit PM tag related by the hardware PM LUT to the transmit RNI; and
passing the transmit PM tag to the transport layer transmit process for insertion into a header in a FIS frame to be passed by the transport layer to the link layer.

23. An article including a machine-accessible medium having associated information, wherein the information, when accessed, results in a machine performing:
relating a port multiplier (PM) tag associated with a frame information structure frame to a remote node context index and to a validity flag using a hardware PM look-up table in a host bus adapter (HBA).

24. The article of claim 23, wherein the information, when accessed, results in a machine performing:
isolating PM tag management operations from other remote node and task context processing in the HBA using PM tag management hardware structures.

25. The article of claim 23, wherein the HBA comprises at least one of a serial advanced technology attachment (SATA) HBA and a serial-attached small computer system interface-SATA tunneled protocol HBA.
